(19) United States
(12) Patent Application Publication
(10) Pub. No.: US 2017/0240247 A1
(43) Pub. Date: Aug. 24, 2017

(54) COAXIALLY SITUATED FRICTION-RING GEAR UNIT FOR A VEHICLE THAT IS ABLE TO BE OPERATED USING MOTOR POWER AND/OR PEDALING POWER

(71) Applicant: Robert Bosch GmbH, Stuttgart (DE)

(72) Inventors: Markus Hinterkausen, Moeglingen (DE); Juergen Hilzinger, Renningen (DE); Peter Kimmich, Steinenbronn (DE)

(21) Appl. No.: 15/519,880

(22) PCT Filed: Aug. 27, 2015
(86) PCT No.: PCT/EP2015/069647

§ 371 Date: Apr. 18, 2017

(30) Foreign Application Priority Data
Oct. 23, 2014 (DE) 102014221512.9

(51) Int. Cl. B62M 11/12; B62M 9/00; F16H 15/20; B62M 25/08; B62M 6/55; B62M 11/14

(52) U.S. Cl. CPC B62M 11/12; B62M 6/55; B62M 11/145; F16H 15/20; B62M 25/08; B62M 9/00

(57) ABSTRACT

A friction-ring gear unit for a vehicle that is operable by motor power and/or pedaling power, in particular for an electrical bicycle having an electric motor, comprising a crankshaft for pedal cranks, and an inner friction ring (26) and an outer friction ring, as well as at least one rotatable dualcone roller which is situated on a roller carrier and is in frictional engagement with the inner friction ring and the outer friction ring, the friction-ring gear unit being situated coaxially around the crankshaft.

### BACKGROUND INFORMATION

The present invention relates to friction-ring gear units (2) for a vehicle that is able to be operated using motor power and/or pedaling power, the friction-ring gear unit in particular being usable in an electrical bicycle (100) equipped with an electric motor (6). The friction-ring gear unit includes a crankshaft for pedal cranks, an inner friction ring and an outer friction ring as well as at least one rotatable dual-cone roller, which is situated on a roller carrier and is in frictional engagement with the inner and the outer friction rings.

Vehicles that are able to be operated using motor power and/or pedaling power and include a friction-ring gear unit are known from the related art, the friction-ring gear unit operating according to the basic principle of the dual-cone friction-ring gear unit, for instance. German Patent Application No. DE 10 2012 209 096 A1 describes a gear unit that is integrated in the vicinity of the bottom bracket and situated paraxially to the crankshaft in a Pedelec/e-bike drive. This allows for a continuous variation of the gear ratio in the bicycle drive.

PCT Application No. WO2014/026754 A1 describes a bicycle gear unit which includes a dual-cone friction-ring gear unit that is likewise situated paraxially to the crankshaft and located in the vicinity of the bottom bracket.

A disadvantage of the related art is that the previously proposed gear units for the bottom bracket are quite large due to their constructive development. This has disadvantages in terms of a lightweight construction, and also restricts the construction freedom of bicycle manufacturers.

### SUMMARY

A friction-ring gear unit according to an example embodiment of the present invention is a coaxially integrated gear unit. The friction-ring gear unit is disposed around the crankshaft. In addition to the general advantages of a friction-ring gear unit, such as a continuously variable translation that is able to be varied in standstill, as well as a quiet operation, there is the special advantage that the drive unit is able to have a very compact design. The implementation as a central drive unit results in a light rear wheel, which goes along with a central center of gravity and, as a result, provides excellent handling and good driving dynamics, and also a pleasant resiliency due to the lower non-resilient masses. In addition, only a single unit is installed on the bicycle when using a central drive. Preferably, the friction-ring gear unit is developed as an integrative module for speed transformation and drive control. The friction-ring gear unit is preferably filled with a traction fluid that has good lubrication characteristics yet still produces high friction between the friction partners in the presence of intense frictional contact. To ensure that the fluid remains in the gear unit, the friction-gear unit preferably has a housing. The housing may have a cylindrical outer shape. Since the friction-ring gear unit is rotationally symmetrical itself, this outer shape results in a compact unit.

Preferred further developments of the present invention are described herein.

In a specific embodiment, the friction-ring gear unit includes a chain wheel or a belt pulley from which the rear wheel is driven, preferably using a traction device. Like the friction-ring gear unit, this chain wheel or the belt pulley is also situated coaxially to the crankshaft, which likewise contributes to a compact design of the drive unit.

In another specific embodiment, a housing of the friction-ring gear unit is designed as a stationary part. This means that the housing does not rotate along with inner components of the drive, in particular the friction-ring gear unit. Toward the outside, only an output element, i.e., the chain wheel or the belt pulley, for instance, as well as the crankshaft are preferably movable. This increases the safety, and offers design engineers multiple options for mounting the drive unit onto the bicycle.

According to another specific embodiment, the friction-ring gear unit has an adjustment device for its translation ratio, whose adjustment path in particular extends along the housing of the friction-ring gear unit, especially in an at least approximately linear manner. More specifically, the adjustment device does not extend coaxially to the friction-ring gear unit, especially not in the interior of the crankshaft. It particularly does not include an adjustment thread. Especially preferably, the adjustment device extends through the housing so that an actuating mechanism may be situated outside the housing, especially on a radial outer surface of the housing. The adjustment device preferably operates in an infinitely variable manner.

According to another specific embodiment, the adjustment device is driven with the aid of a positioning motor. For example, the adjustment of the gear ratio may thereby be integrated into an integrated management system for the drive unit. The positioning motor may be situated on the outer periphery or in the vicinity of the outer periphery of the friction-ring gear unit. In addition, it is possible to place the positioning motor in or on the vehicle, independently of the friction-ring gear unit, the positioning motor preferably being connected via a tele-control device such as a Bowden cable or a positioning linkage to the friction-ring gear unit.

According to another specific embodiment, the rotational speed of the friction-ring gear unit is increased in relation to the rotational speed of the crankshaft in that a pre-gear with a speed-increasing ratio is connected upstream from the friction-ring gear unit. The pre-gear, in particular, may be implemented as a planetary gear. One advantage of the increased rotational speed of the friction-ring gear unit is that it needs to transmit lower torques at the same output. Therefore, it may have a more delicate design than without the pre-gear. If the power of the motor is coupled into the energy flow through the gear unit at a location running at an increased speed, then the motor is likewise able to run at a greater rotational speed and may therefore have a lighter and smaller design at the same output. In particular, the motor has a higher maximum rotational speed. In some cases, the motor gear unit may also have a more compact design, for instance because it must have a lower gear ratio at the same motor speed and has to transmit lower torques. As an alternative, the gear ratio may be maintained so that the rotational speed of the motor is increased. The motor may then have a smaller and lighter design at the same output. It is especially preferred that energy from the motor is coupled in at the output of the pre-gear. In addition, the pre-gear is able to reverse the direction of rotation, which may subsequently be canceled again by the friction-ring gear unit.

According to another specific embodiment, the drive unit has a post-gear in the flow of power downstream from the friction-ring gear unit, which reduces the rotational speed of the output of the friction-ring gear unit and limits it, in particular. A suitable torque is thereby able to be achieved at the output of the drive unit. The post-gear may be developed as a planetary gear. The planetary gear is preferably integrated in such a way that there will be no reversal in the direction of rotation. The ring gear is stationary, in particular, and the sun wheel is driven, so that the planetary gear carrier constitutes the output.

According to another specific embodiment, the drive unit includes a summing gear wheel at which torque from the crankshaft that is generated by pedaling force, and torque from the motor are summed up. The summing gear wheel in particular is a toothed gear into which torque from the motor is introduced via an engagement of a toothed gear that is connected to the motor in a power-transmitting manner. The introduction of the torque from the crankshaft preferably takes place centrally from a shaft or some other element whose center axis coincides with the center axis of the summing gear wheel and which is connected to the summing gear wheel in a torque-proof manner. Especially preferably, a ring gear of a pre-gear implemented as a planetary gear is situated in the interior of the summing gear wheel. Such a positioning of the ring gear in relation to the summing gear wheel advantageously reduces the axial length of the gear unit. The summing gear wheel may be situated around a drive-friction ring of the friction-ring gear unit, in particular around an outer friction ring. The rotational speed of the summing gear wheel at this position is increased in comparison with the rotational speed of the crankshaft, so that the rotational speed of the motor may also be higher. The motor may then be developed in a lighter and more compact form.

In another specific embodiment, an intermediate gear is connected between the motor and the summing gear wheel, which causes the rotational speed of the motor to increase. The motor is an electric motor, in particular, which when designed for higher rotational speeds and a lower torque, may be more compact and lighter while supplying the same output. The intermediate gear may be situated eccentrically to the friction ring and the crankshaft. The intermediate gear is able to act on the summing gear wheel of the drive unit. Toothed wheels of the intermediate gear may be spur-toothed wheels. In another specific embodiment, the vehicle includes a freewheel which, despite a rigid coupling of the motor with the gear unit, allows the crankshaft to be moved independently of the motor when the equivalent speed of the motor is greater than that of the crankshaft. In addition, the freewheel makes it possible to move the crankshaft in reverse or to not move it despite the motor and/or the vehicle moving forward. Preferably, the freewheel is situated in the flow of power between the crankshaft and a subsequently following power-transmission element. The freewheel preferably has such a small diameter that it is able to be placed in the interior of another component. In particular, it is situated in the interior of the sun gear of a pre-gear. The freewheel may extend up to and into the friction-ring gear unit. The positioning in the interior of another element makes it possible to save axial length. In particular, a freewheel, especially the same freewheel as between the friction-ring gear unit and the crankshaft, is furthermore situated in a power flow from the motor to the crankshaft. The freewheel may be a ratchet freewheel, for instance.

In another specific embodiment, a plurality of freewheels having the same function are connected in parallel and situated at the same location in the flow of power. This makes it possible to transmit a higher torque, and/or the individual freewheels have to transmit less torque, so that more compact developments, in particular developments having a smaller diameter, may be used. The freewheels are preferably situated in one row next to one another. In particular, two or three freewheels are used.

According to another aspect of the present invention, a drive unit for a vehicle is provided, in particular for a vehicle that is able to be operated using pedaling power and/or motor power, especially an electrical bicycle having an electric motor, the drive unit including a friction-ring gear unit according to one of the afore-described specific embodiments. This results in the advantages mentioned with reference to the afore-described friction-ring gear unit.

According to another aspect, a vehicle that is operable by pedaling power and/or motor power, especially an electrical bicycle having an electric motor, is provided which has a friction-ring gear unit according to one of the afore-described specific embodiments.

### BRIEF DESCRIPTION OF THE DRAWINGS

Below, exemplary embodiments of the present invention are described in detail with reference to the accompanying figures.

FIG. 1 shows a schematic representation of an electrical bicycle, which is equipped with a specific embodiment of a drive unit including a friction-ring gear unit according to the present invention.

FIG. 2 shows a perspective view of an integrated drive unit having a friction-ring gear unit according to the present invention.

FIG. 3 shows a perspective view of an integrated drive unit in the specific embodiment shown in FIG. 2, without a housing surrounding the friction-gear unit.

FIG. 4 shows a cross-section along a center axis of the roller carrier through the gear unit shown in FIG. 3, including the summing gear wheel, pre-gear, friction-ring gear unit, and post-gear.

FIG. 5 shows a detail with a dual-cone roller from the cross-section shown in FIG. 4, in an enlarged view.

### DETAILED DESCRIPTION OF EXAMPLE EMBODIMENTS

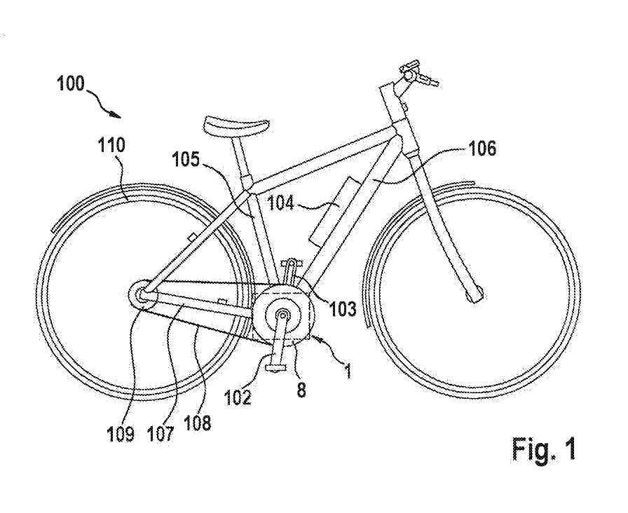

FIG. 1 schematically shows an electrical bicycle 100, in which a drive unit 1 is centrally situated on the frame. In particular, seat tube 105, downtube 106, and chain stay 107 come together at drive unit 1 or in its vicinity. The bearing mount of the crankshaft for pedal cranks 102 and 103 is integrated in drive unit 1. The drive unit has a chain wheel 8 which represents the output of drive unit 1. Chain wheel 8 transmits a torque from drive unit 1 via a chain 108 and a chain pinion 109 to a rear wheel 110. Drive unit 1 includes an electric motor, which is not explicitly shown. The electric motor may be supplied with energy from a battery 104.

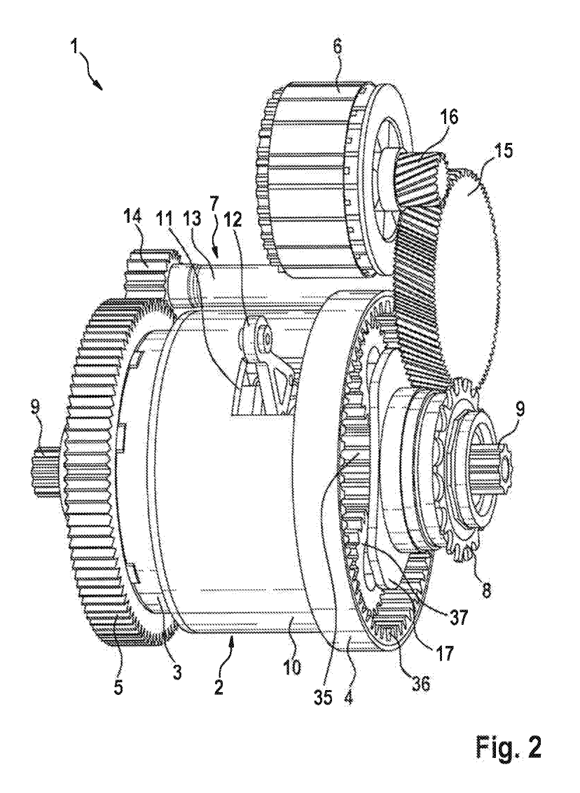

FIG. 2 shows as a perspective view an integrated drive unit 1, which includes a friction-ring gear unit 2, a pre-gear 3, a post-gear 4, a summing gear wheel 5, an electric motor 6, an intermediate gear 7, an output 8 and a crankshaft 9. Crankshaft 9 is shown without its cranks, which may be slipped over a respective gear coupling at the end of crankshaft 9; however, other connection types are possible as well. Friction-ring gear unit 2 has a housing 10, which surrounds friction-ring gear unit 2 at least radially with the exception of a cutout 11. From the interior of the housing, an adjustment lever 12 as part of the friction-ring gear unit projects through cutout 11. It is displaceable in the longitudinal direction of crankshaft 9 and thereby allows an adjustment of the gear ratio of friction-ring gear unit 2. The adjustment travel, executed by adjustment lever 12, of the adjustment device thus runs in the interior of cutout 11 in relation to adjustment lever 12 and in the longitudinal direction of crankshaft 9. The adjustment travel is at least approximately linear.

Intermediate gear 7 includes an intermediate shaft 13 at whose one end a pinion 14 is situated, which meshes with summing gear wheel 5. The bearing assembly of intermediate shaft 13 is not shown. Pinion 14 has a considerably smaller diameter than summing gear wheel 5. An intermediate toothed wheel 15 having a considerably larger diameter than pinion 14 is situated at the other end of intermediate shaft 13. Intermediate toothed wheel 15 meshes with an output toothed wheel 16 of an electric motor 6, which is part of drive unit 1. In this way, a considerable step-down ratio of the rotational speed of electric motor 6 in relation to the rotational speed of summing gear wheel 5 is brought about via intermediate gear 7. Because of the high rotational speed, electric motor 6 is able to be given a relatively small and compact design at the same output. A mechanical connection between electric motor 6 and housing 10 of friction-ring gear unit 2 is not shown.

Post-gear 4 is developed as a planetary gear whose output is planetary-wheel carrier 17. Planetary-wheel carrier 17 is connected in a torque-proof manner to chain wheel 8 of the output of the integrated gear unit. The drive of the planetary gear takes place via sun gear 35 while ring gear 36 is connected to housing 10 in a torque-proof manner. An external cover of post-gear 4, which may be developed in a completely sealed manner, is not shown.

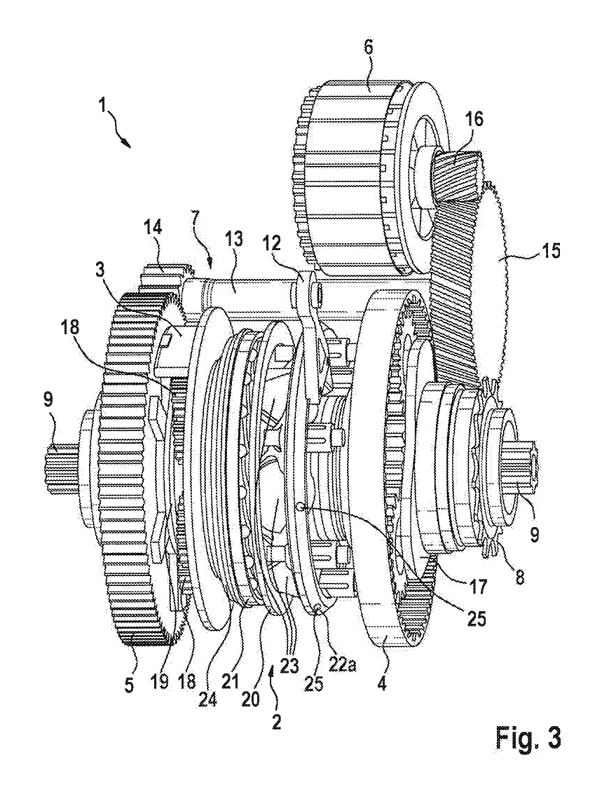

FIG. 3 shows the same integrated drive unit 1 as FIG. 2 in a perspective view, but with the difference that housing 10 of friction-ring gear unit 2 has been omitted so that its details are visible. In addition, a portion of the ring gear of the pre-gear 3, which is developed as a planetary gear, has been left off, so that its planetary wheels 18 and its planetary-wheel carrier 19 are visible. Features and elements that were described in FIG. 1 have been provided with the same reference numerals and will not be separately described again. Reference is made to FIG. 1 in this regard.

Friction-ring gear unit 2 includes an outer friction ring 20, which is in frictional engagement with a plurality of dual cones 23. Dual cones 23 are situated on a roller carrier 22 and rotate on axles 25 mounted thereon. Roller carrier 22 has a non-visible part, which lies further in the interior of friction-ring gear unit 2. Outer friction ring 20 is connected to an expanding coupling 21, which in turn is braced via an axial bearing 24 on a housing part that is not shown. Expanding coupling 21 expands in the axial direction of crankshaft 9 when a drive torque from summing gear wheel 5 is acting on friction-ring gear unit 2. This increases the contact pressure between outer friction ring 20 and dual-cone rollers 23. Adjustment lever 12 is connected to roller carrier 25, which is designed to be displaceable in the axial direction of crankshaft 9. Expanding coupling 21 may include springs or may be connected to springs which induce a preloading force between outer friction ring 20 and dual-cone rollers 23.

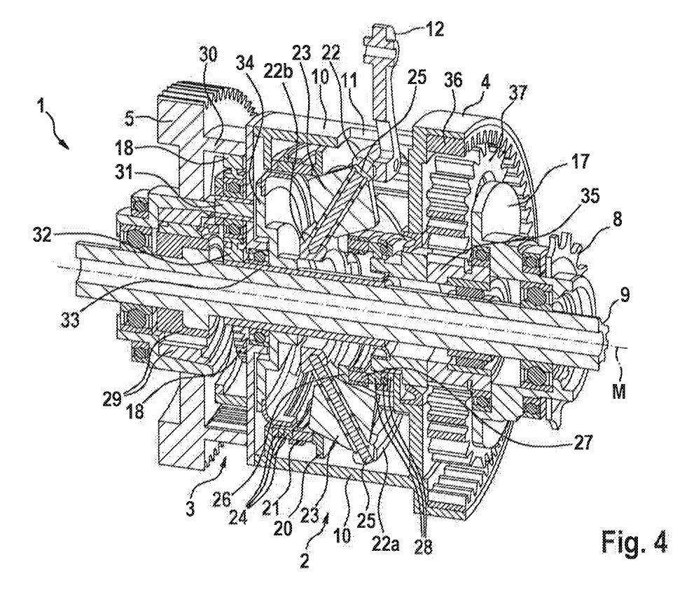

FIG. 4 perspectively shows a cross-section through integrated drive unit 1 that is shown in FIG. 3. The cross-section runs through a center axis M of crankshaft 9 and through adjustment lever 12. Features and elements that were already described in FIGS. 2 and 3 have been provided with the same reference numerals and will not be separately described again. Reference is made to FIGS. 2 and 3 in this regard.

FIG. 4 shows the inner part of roller carrier 22. It is connected via roller axles 25 to the outer part of roller carrier 22. Also shown is inner friction ring 26, which is in frictional engagement with dual cones 23. An expanding coupling 27, which is braced on housing 10 via an axial bearing 28, is allocated to inner friction ring 26. Like expanding coupling 21, expanding coupling 28 is designed in such a way that it is expanded in the longitudinal direction of crankshaft 9 in response to a drive torque that is acting on summing gear wheel 5, so that the contact pressure between inner friction ring 26 and dual-cone rollers 23 is increased. Expanding coupling 27 may include springs or may be connected to springs, which induce a preloading force between inner friction ring 26 and dual-cone rollers 23. The diameter of expanding coupling 21 is smaller than that of expanding coupling 27.

The following text describes the power flow through the part of drive unit 1 shown in FIG. 4. A torque is able to be introduced into crankshaft 9 via cranks (not shown) by pedaling force. The torque in crankshaft 9 is introduced into summing gear wheel 5 via a freewheel 29. Freewheel 29 has the effect of allowing reverse pedaling while the rest of the depicted gear unit rotates in accordance with the revolutions of its output 8. Summing gear wheel 5 is connected to ring gear 30 of pre-gear 3 in a torque-proof manner so that both rotate together. Planetary wheels 18 of pre-gear 3 are fixed in place on planetary shafts 31, which are mounted on housing 10. Thus, the position of planetary wheels 18 is fixed with the exception of their own rotation. Sun gear 32 of the pre- gear is connected in a torque-proof manner to a sleeve 33, which conducts the torque from sun gear 32 to friction-ring gear unit 2. Because of the step-up ratio of pre-gear 3, the rotational speed of sleeve 33 is higher than the rotation of summing gear wheel 5. Sleeve 33 is slipped onto crankshaft 9 in a manner that allows it to rotate. A drive disk 34, which transmits the torque from sleeve 33 via expanding coupling 21 to outer friction ring 20, is pressed onto sleeve 33. The torque is then transmitted to dual-cone rollers 23. Since roller carrier 22 is disposed in a non-rotatable manner but is displaceable only in the longitudinal direction of crankshaft 9, the torque is fully transferred into a rotation of dual-cone rollers 23 by outer friction ring 20. Dual-cone rollers 23 transmit the torque further to inner friction ring 26 with which they are also in frictional engagement. Via expanding coupling 27, the torque is transmitted further to sun gear 35 of post-gear 4. Ring gear 36 of post-gear 4 is connected to housing 10 in a torque-proof manner. Thus, the torque is transmitted to planetary-wheel carrier 17 of planetary wheels 37 of post-gear 4. As already mentioned, planetary-wheel carrier 17 of post-gear 4 is connected to the output, preferably implemented as a chain wheel 8, in a torque-proof manner, so that the torque from integrated gear unit 1 is able to be picked off there, such as via a chain.

As already mentioned, outer friction ring 20 and inner friction ring 26 are braced on housing 10 by respectively allocated axial bearings 24 and 28. In the specific embodiment of FIGS. 1 through 3, housing 10 thus forms a force-return flow device for the forces that stem from expanding couplings 21 and 27, in particular. These forces correspond to the press forces on dual-cone rollers 23. Axial bearings 24 and 28 are running at the rotational speed of large friction ring 20 or small friction ring 26, respectively. Axial bearing 24 of the large friction ring, in particular, generates a relatively high moment of friction because it has a high rotational speed in many operating states and also has a large friction radius.

Crankshaft 9 is situated concentrically to roller carrier 22, axial bearings 24 and 28, expanding couplings 21 and 27 as well as small friction ring 26 and large friction ring 20. In addition, pre-gear 3 and post-gear 4, both of which are implemented as planetary gears, are situated concentrically to crankshaft 9. The same holds true also for summing gear wheel 5 and the chain wheel of output 8.

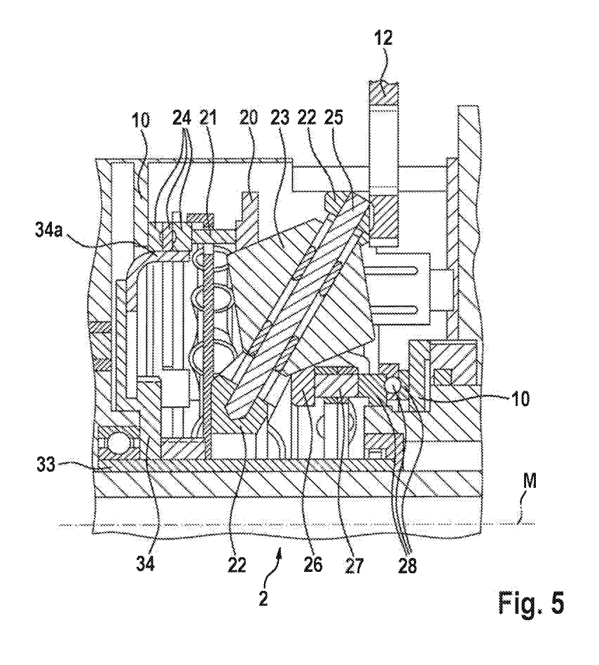

FIG. 5 shows a cut-away of the cross-section, depicted in FIG. 4 in a perspective view, which includes friction-ring gear 2, in a view shown as a semi-section. Identical features and elements are denoted by the same reference numerals and are not separately described again. Reference is made to FIG. 4 in this regard. It is easy to see in FIG. 5 that drive disk 34 includes an edge 34a that is bent over in the axial direction, via which torque is conducted from sleeve 33 to expanding coupling 21.

1-15. (canceled)

16. A friction-ring gear unit for a vehicle that is able to be operated using motor power and/or pedaling power, the vehicle being an electrical bicycle having an electric motor, the friction-ring gear unit comprising:
a crankshaft for pedal cranks; and
an inner friction ring, an outer friction ring, and at least one rotatable dual-cone roller which is situated on a roller carrier and is in frictional engagement with the inner friction ring and the outer friction ring;
wherein the friction-ring gear unit is situated coaxially around the crankshaft; and
wherein the friction-ring gear unit has an adjustment device for its translation ratio, which is movable along an adjustment path that extends inside a housing of the friction-ring gear unit and is at least approximately linear, by which the roller carrier is axially displaceable in relation to the friction rings.

17. The friction-ring gear unit as recited in claim 16, wherein the friction-ring gear unit includes one of a chain wheel or a disk pulley, the one of the chain wheel or the disk pulley being situated coaxially to the crankshaft.

18. The friction-ring gear unit as recited in claim 16, wherein the housing of the friction-ring gear unit at least partially surrounds the friction-ring gear unit and does not rotate during operation of the friction-ring gear unit.

19. The friction-ring gear unit as recited in claim 16, wherein the friction-ring gear unit has a positioning motor for adjusting the adjustment device.

20. The friction-ring gear unit as recited in claim 16, wherein a pre-gear is connected upstream from the friction-ring gear unit, which increases a drive speed of the friction-ring gear unit in relation to a drive speed of the pre-gear.

21. The friction-ring gear unit as recited in claim 20, wherein the pre-gear is a planetary gear.

22. The friction-ring gear unit as recited in claim 20, wherein energy from the electric motor is coupled into an output of the pre-gear.

23. The friction-ring gear unit as recited in claim 20, wherein a post-gear is connected downstream from the friction-ring gear unit, by which the output speed of the friction-ring gear unit at an output of the post-gear is reduced.

24. The friction-ring gear unit as recited in claim 23, wherein the post-gear is a planetary gear.

25. The friction-ring gear unit as recited in claim 20, wherein the friction-ring gear unit has a summing gear wheel which sums up torque from the electric motor, and torque from the crankshaft, and which is situated at a drive of the pre-gear, the summing gear wheel being connected in a torque-proof manner to a ring gear of a planetary gear connected as pre-gear upstream from the friction-ring gear unit.

26. The friction-ring gear as recited in claim 25, wherein the summing fear wheel is a toothed wheel.

27. The friction-ring gear unit as recited in claim 25, wherein the summing gear wheel is situated around a drive-friction ring of the friction-ring gear unit.

28. The friction-ring gear unit as recited in claim 25, wherein an intermediate gear is connected between the motor and the summing gear wheel, which induces a step-down ratio from the motor to the summing gear wheel.

29. The friction-ring gear unit as recited in claim 16, wherein the friction-ring gear unit includes a freewheel which allows for reverse pedaling that has no effect on the vehicle motion, the electric motor remaining unaffected by the reverse pedaling.

30. The friction-ring gear unit as recited in claim 16, wherein the friction-ring gear unit has a plurality of freewheels which are connected in parallel.

31. A vehicle that is able to be operated using motor power and/or pedaling power, the vehicle being an electrical bicycle having an electric motor, the vehicle including a friction-ring gear unit and a crankshaft, which are situated concentrically to each other, wherein the friction-ring gear unit has an adjustment device for its translation ratio, which is movable along an adjustment path that extends inside a housing of the friction-ring gear unit and is at least approximately linear, by which the roller carrier is axially displaceable in relation to friction rings of the friction-ring gear unit, the adjustment device extending through the housing.

32. The vehicle as recited in claim 31, wherein the vehicle has a positioning motor for adjusting the adjustment device.
